(19) United States
(12) Patent Application Publication
(10) Pub. No.: US 2006/0203267 A1
(43) Pub. Date: Sep. 14, 2006

(54) Image forming apparatus and image forming method

(75) Inventor: Masatsugu Hirayama, Yokohama-shi (JP)

Correspondence Address: FOLEY AND LARDNER LLP;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 11/076,209

(22) Filed: Mar. 10, 2005

(51) Int. Cl. G06F 15/00

(52) U.S. Cl. 358/1.9; 358/3.06

(57) ABSTRACT

An image forming apparatus comprising a control unit which controls a reading unit, a memory unit, a computing unit, an image processing unit, and an image forming unit such that the reading unit reads image information of a document only once, the computing unit receives the image information to compute a density histogram during an interval in which the image information is stored in the memory unit, the memory unit reads the image information to supply the image information to the image processing unit, the image processing unit performs density adjustment to the read image information according to the density histogram and outputs the image information, and the image forming unit forms an image to which the density adjustment has been performed according to the density histogram of the document image by one-time image reading of the reading unit.

### BACKGROUND OF THE INVENTION

Recently as performance of an image forming apparatus such as a digital copying machine is improved, integrated digital equipment having not only a copying function but a printer function is developed and is becoming widespread. In the image forming apparatus such as the integrated digital equipment, further improvements are desired for each function.

U.S. Pat. No. 6,631,209 discloses a method of automatically performing appropriate density adjustment to a document read, in which pre-scan is performed to correct densities of a background and characters based on histogram data and the like of the whole document. However, in the method disclosed in U.S. Pat. No. 6,631,209, after the histogram and the like are determined by the pre-scan action, the image of the document is scanned again in order to make copy. Therefore, when the plural documents are continuously copied, there is generated a problem that processing speed is not sufficiently increased because two-time scanning processes are required for one sheet of document.

### BRIEF SUMMARY OF THE INVENTION

An embodiment of an image forming apparatus according to the present invention is an image forming apparatus comprising: a reading unit which reads a document image to output image information; a memory unit which stores the image information read by the reading unit in a storage area; a computing unit which computes a density histogram of the image information from the reading unit; an image processing unit which performs density adjustment to the image information read from the memory unit according to the density histogram computed by the computing unit, and outputs the image information; an image forming unit which forms an image based on the image information to which the image processing unit has performed the density adjustment; and a control unit which controls the reading unit, the memory unit, the computing unit, the image processing unit, and the image forming unit such that the reading unit reads the image information of the document only once, the computing unit receives the image information to compute the density histogram during an interval in which the image information is stored in the memory unit, the memory unit reads the image information to supply the image information to the image processing unit, the image processing unit performs the density adjustment to the read image information according to the density histogram and outputs the image information, and the image forming unit forms the image to which the density adjustment has been performed according to the density histogram of the document image by one-time image reading of the reading unit.

### BRIEF DESCRIPTION OF THE SEVERAL VIEWS OF THE DRAWING

FIG. 1 is a block diagram showing a configuration of an image forming apparatus according to an embodiment of the present invention;

FIG. 2 is a block diagram showing a configuration of a print data image processing unit of the image forming apparatus;

FIG. 3 is a block diagram showing a configuration of a density adjusting unit included in the print data image processing unit of the image forming apparatus;

FIGS. 4A and 4B are graphs showing an image data histogram generated by a computing unit of the image forming apparatus, and FIG. 4C show an image pixel skipping process performed by the computing unit of the image forming apparatus;

FIGS. 5A to 5E are graphs each showing a density adjusting curve of the image forming apparatus;

FIG. 6 is a graph showing gradation conversion of the image forming apparatus;

FIG. 7 shows photograph images of pre-gradation conversion and post-gradation conversion of the image forming apparatus;

FIG. 8 is a flowchart showing image processing of the image forming apparatus in the case of the absence of electronic sort;

FIG. 9 is a flowchart showing image processing of the image forming apparatus in the case of the presence of electronic sort;

FIG. 10 is an explanatory view for explaining N in 1 performed by the image forming apparatus;

FIGS. 11A and 11B are graphs each showing a density adjusting curve in the case of 4 in 1 performed by the image forming apparatus; and

FIG. 12 is an explanatory view for explaining a density adjustment switching process in the case of 4 in 1 performed by the image forming apparatus.

### DETAILED DESCRIPTION OF THE INVENTION

Referring now to the accompanying drawings, an image forming apparatus and an image forming method according to an embodiment of the invention will be described in detail.

In the image forming apparatus according to the embodiment of the invention, while a memory unit such as a page memory is prepared to store image information obtained by the scanning in the page memory, a density histogram is generated for the same image information to determine the amount of density adjustment according to the density histogram. When the image information is read from the page memory, the density adjustment of the image information is performed. Thus, timing between “density histogram computing process” and “read image information storage and density adjusting process” can be synchronized by temporarily storing the image information in the page memory, however, relatively long times are required for the density histogram computing process and the read image information storage and density adjusting process. Therefore, the document image subjected to the density adjustment corresponding to the density distribution of the document image can continuously be produced by one-time scanning per one sheet of the document.

### Image Forming Apparatus of the Embodiment

(Configuration)

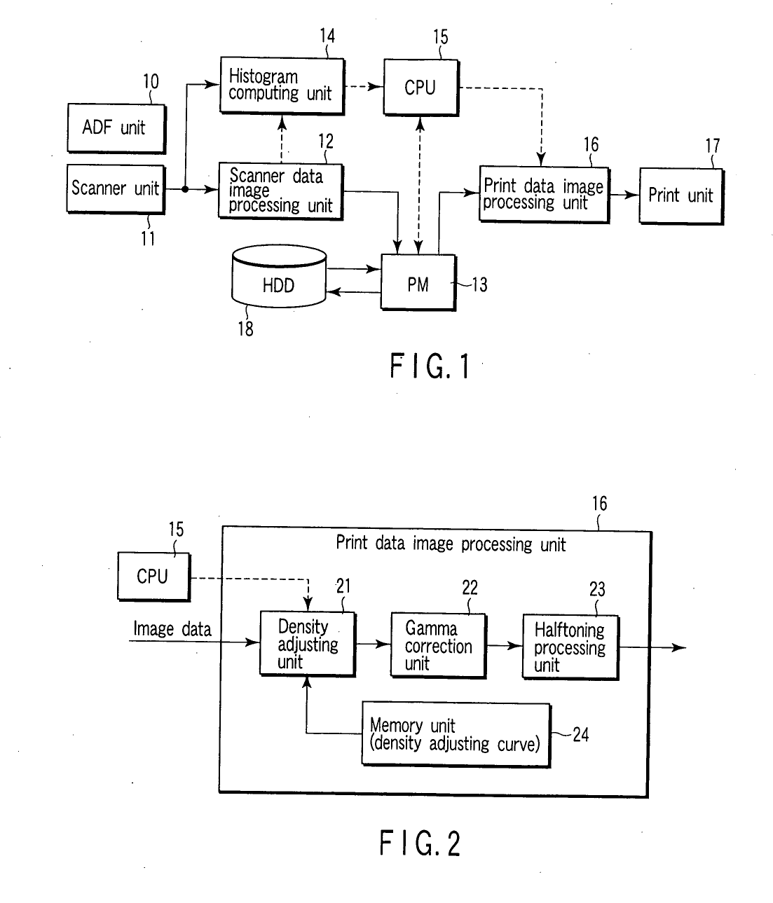

FIG. 1 is a block diagram showing the image forming apparatus according to the embodiment of the invention. In FIG. 1, an image forming apparatus 1 includes a auto document feeder (ADF) unit 10, a scanner unit 11, a scan data image processing unit 12, and a page memory unit (hereinafter referred to as PM) 13. The ADF unit 10 automatically conveys a document. The scanner unit 11 scans a document image. The scanner unit 11 supplies input RGB image signals to the scan data image processing unit 12. The scan data image processing unit 12 performs processes such as a color conversion process and a filtering process. In the color conversion process, the RGB image signals are converted into CMY signals which are of recording colors. The PM 13 stores the image signals processed by the scan data image processing unit 12. The image forming apparatus 1 also includes a histogram computing unit 14, a CPU 15, a print data image processing unit 16, and a print unit 17. The histogram computing unit 14 produces a histogram based on RGB image signals and the like from the scanner unit 11. The CPU 15 controls the whole actions. The print data image processing unit 16 receives computation data such as ground density, control signals, the image signals read from the PM 13 to perform the density adjustment based on a direction of the CPU 15, thereby supplying print data. The print unit 17 receives the print data to form an image. In the histogram computing unit 14 and the print data image processing unit 16, it is preferable that an image data format of the dealt image information is standardized. However, the invention is not limited to the standardization of the image data format.

In FIG. 2, the print data image processing unit 16 in the image forming apparatus 1 according to the embodiment of the invention includes a density adjusting unit 21, a gamma correction unit 22, halftoning processing unit 23, and a memory unit 24. The density adjusting unit 21 receives the control signals from the CPU 15 and the image information from the PM 13. The gamma correction unit 22 receives the output of the density adjusting unit 21 to perform gamma correction. The halftoning processing unit 23 performs gradation process of the image information to which the gamma correction has been already performed. The memory unit 24 provides a density adjusting curve to the density adjusting unit 21.

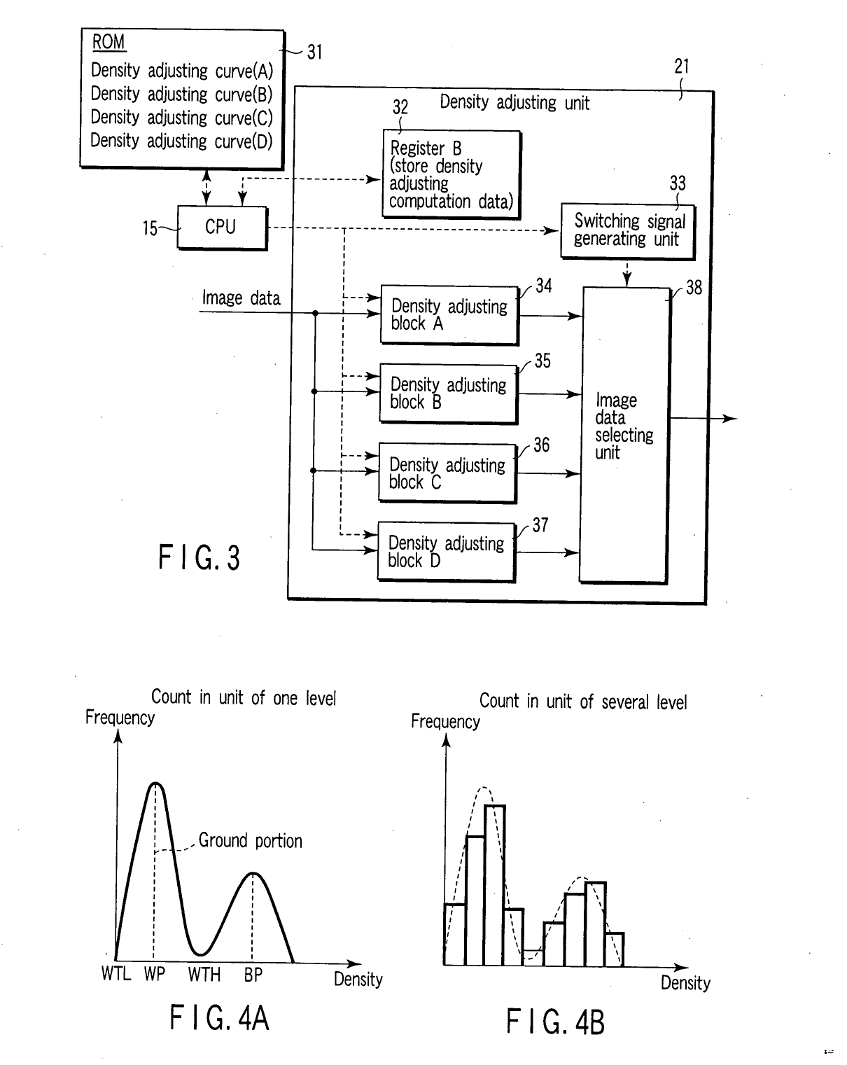

In FIG. 3, the density adjusting unit 21 is connected to the CPU 15 which is connected to a ROM 31 for storing and supplying plural density adjusting curves. The density adjusting unit 21 includes a register MB 32, a density adjusting block A 34, a density adjusting block B 35, a density adjusting block C 36, a density adjusting block D 37, an image data selecting unit 38, and a switching signal generating unit 33. The PM 13 supplies the image information to the density adjusting blocks A to D 34 to 37. The outputs of the density adjusting blocks A to D 34 to 37 are supplied to the image data selecting unit 38, and the image data selecting unit 38 selectively outputs one piece of image data. The switching signal generating unit 33 supplies switching signals to the image data selecting unit 38 in response to the control signal from the CPU 15.

(Image Forming Process Accompanied by Image Adjustment by One-time Scan)

Now, the image forming process accompanied by image adjustment by one-time scan in the image forming apparatus 1 will be described referring to a flowchart shown in FIG. 8. In the following description, an image in a document is read by one-time scan without using an electronic sort mode, the density adjustment is performed according to the document image, and an image is formed on a recording medium.

In the flowchart of FIG. 8 of the image forming apparatus 1, the document is conveyed to a document glass with the ADF 10, and the image in the document is read by the scanner unit 11 (S11). The image data (eight bits in each color of RGB) of the document read by the scanner unit 11 is supplied to the scan data image processing unit 12 under the control of the CPU 13 or the like, and desired image processing such as an image conversion process is performed in the scan data image processing unit 12 (S12). Then, the data is stored in a storage area of the PM 13 (S13). The image information of the read document of at least one page or more is stored in the PM 13.

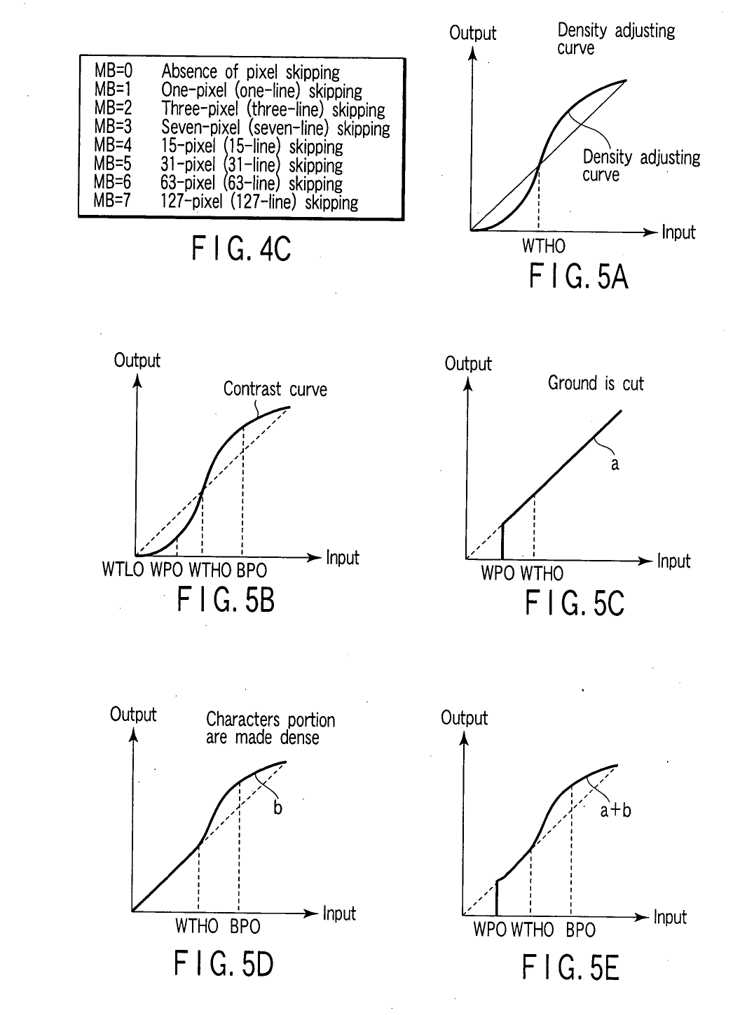

In order to produce a histogram shown in FIGS. 4A and 4B, in parallel with the image processing and storage process, the histogram computing unit 14 extracts the image information which is of an object of the histogram (S21). In the histogram, a horizontal axis indicates density and a vertical axis indicates frequency. As shown in FIG. 4C, values of a three-bit pixel-skipping setting register MB are specified as follows:

MB=0 Absence of pixel skipping,

MB=1 One-pixel (one-line) skipping,

MB=2 Three-pixel (three-line) skipping,

MB=3 Seven-pixel (seven-line) skipping,

MB=4 15-pixel (15-line) skipping,

MB=5 31-pixel (31-line) skipping,

MB=6 63-pixel (63-line) skipping, and

MB=7 127-pixel (127-line) skipping.

In the histogram computing unit 14, only the pixels which are of the object of the histogram are extracted in order to perform the pixel skipping shown by the value of the setting register MB. As used herein, the term “three-pixel (three-line) skipping” means the process of:

ON/OFF/OFF/OFF/ON/OFF/OFF/OFF, . . . .

Accordingly, because the number of pixels which ARE of the object of the histogram is decreased to a quarter, the processing speed is increased. Similarly, as the number of skipping pixels is increased, the processing speed is further increased. Therefore, because a generation time of the density histogram is shortened, the process of storing the image information in the PM 13 can easily be synchronized with the process of generating the density histogram. The image information storing process is performed in parallel with the density histogram generating process.

Further, for the image information read by the scanner unit 11, it is possible to specify a count reference area. For example, an area smaller than the document can be used for the histogram computation by specifying a start coordinate (xs, ys) and an end coordinate (xe, ye) of the reference area with respect to the upper left of the document. Therefore, because the time for generating the density histogram is also shortened, the time for generating the density histogram can easily be synchronized with the process of storing the image information in the PM 13.

Then, the histogram computing unit 14 generates the density histogram for the image information in which the pixel skipping process has been appropriately performed (S22). As shown in FIG. 4A, for unit of one level, it is necessary that the frequency is recorded for 256 registers A (histogram computing unit). However, as shown in FIG. 4B, it is also possible that the frequency is counted in unit of several levels. In the histogram computing unit 14, it is preferable that one pixel of the image information is not counted as one frequency, but the plural pixels are counted as one frequency to compute the density histogram. In FIG. 4A, WP designates ground peak density, WTH designates ground valley upper limit density, WTL designates ground valley lower limit density, and BP designates character peak density.

As shown by a broken line from the scan data image processing unit 12 to the histogram computing unit 14 in FIG. 1, it is preferable that the scan data image processing unit 12 supplies the image information, to which the color conversion process and the filtering process are performed, to the histogram computing unit 14 and the histogram computing unit 14 produces the density histogram for the image information. In the color conversion process, the RGB image signals are converted into the CMY signals which are of the recording colors.

The histogram computing unit 14 or the CPU 15 detects ground density information and character density information from the detected histogram data, and the information are stored in the register MB included in the density adjusting unit 21 of the print data image processing unit 16 shown in FIG. 2 (S23).

One of the plural density adjusting curves supplied from the memory unit 24 is selected by the workings of the CPU 15 and the print data image processing unit 16 according to the ground information such as WP, WTH, WTL, and BP and the character density information, and the selected density adjusting curve is set in the density adjusting unit 21 (S14). As used herein, the term “the plural density adjusting curves” means the plural density adjusting curves which are previously prepared as shown in FIGS. 5B to 5E. FIG. 5B shows a contrast curve, FIG. 5C shows a density adjusting curve in which the ground is cut, FIG. 5D shows a density adjusting curve in which a character portion is emphasized, and FIG. 5E shows a density adjusting curve in which the density adjusting curve shown in FIG. 5C and the density adjusting curve shown in FIG. 5D are composed.

Then, the image information is read from the PM 13 (S15), and the set density adjustment is performed to the image information (S16). In the density adjusting unit 21 of the print data image processing unit 16, the density adjustment is performed to the image information according to the density adjusting curve shown in FIG. 5A, thereby improving contrast of the whole image while suppressing ground fog. In the print data image processing unit 16, the gamma correction unit 22 performs the gamma correction process after the density adjustment, and the halftoning processing unit 23 sends print data to the print unit 17. Consequently, the print unit 17 forms the image on the recording medium according to the image information (S17).

In the image forming apparatus 1, the density correction is performed to form the image according to the density histogram of the image information on the document by the one-time scan process per one sheet of document. Accordingly, when compared with the conventional image forming process including the pre-scan and the real scan, the processing time can be shortened by about 50%. Further, the image forming process of the embodiment can continuously be performed to the plural documents by using the ADF 10. Therefore, the high-speed image forming process with the image density process can be performed by the one-time scan process per one sheet of document.

Other Methods

In the density adjusting process, when the adjustment is performed by the gradation conversion using the maximum density (Dmax) and the minimum density (Dmin) of the input image data, Dmax and Dmin with the image data are temporarily stored in the HDD 18, and Dmax and Dmin with the image data are read through the PM 13, which allows the suitable density adjustment to be performed in unit of page in the print data image processing unit 16.

It is preferable that Dmax and Dmin of the input image data are detected to use Dmax and Dmin instead of the computation of the histogram in the histogram computing unit 14. In consideration of a noise of the scanner output, it is possible to detect the histogram data to which a smoothing process is performed. As a result, a range of the input image data can be grasped for an eight-bit (0 to 255) dynamic range, and a gradation conversion function utilized in the dynamic range can be computed. At this point, in the case where the gradation conversion is performed by linear conversion, assuming that the density before the conversion is D, the density after the conversion D′ is given by the following equation:
D′=(D−Dₘᵢₙ)×255/(D−Dₘᵢₙ)

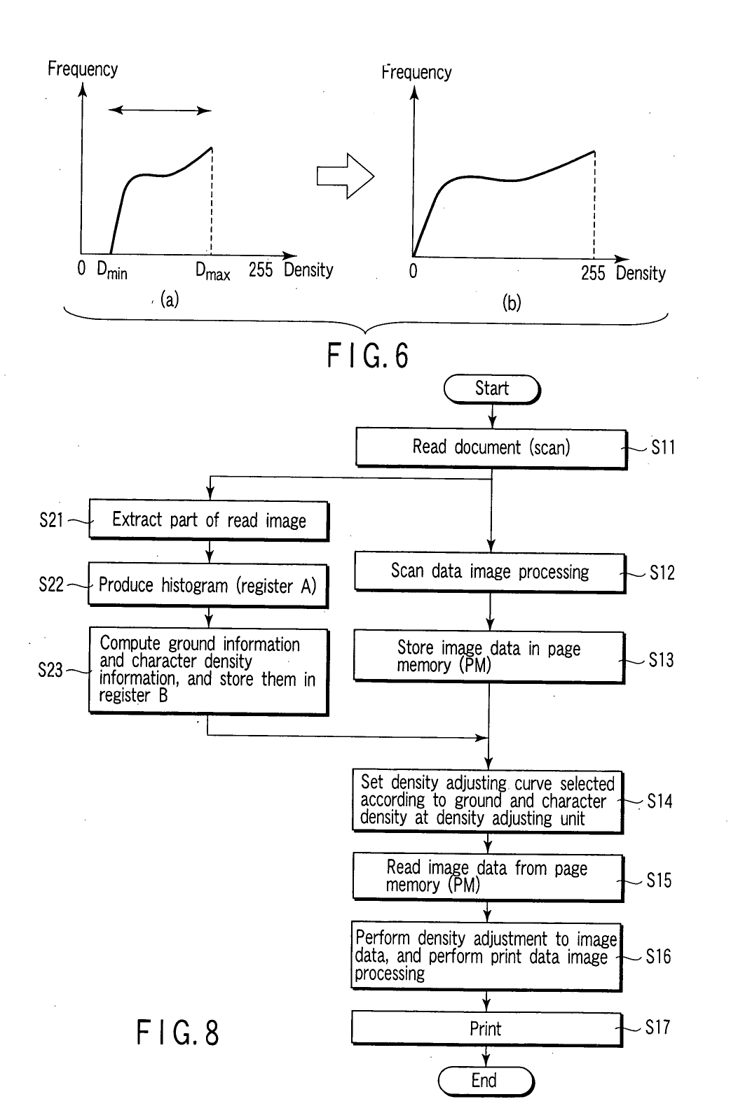

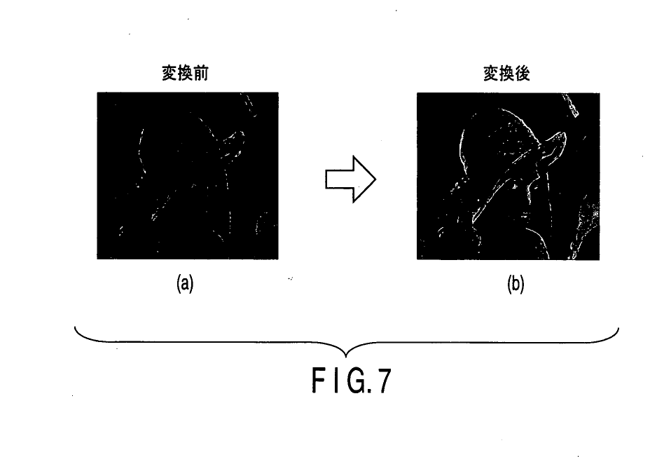

FIG. 6 shows density distributions of the gradation image before and after the conversion in the density adjustment. FIG. 7 shows examples of real images before and after the conversion. The obtained equation is set as a density adjustment table of the print data image processing unit 16, and the density adjustment table is applied to the image data inputted from the PM 13 to the print data image processing unit 16, which allows the image to be improved in the contrast.

When piecewise linear conversion in which D₁, D₂, . . . , Dᵢ, D_{i*1}, . . . , D_{N} are caused to correspond to D₁′, D₂′, . . . , Dᵢ′, D_{i*1}′, . . . , D_{N}′ is applied to the gradation conversion, the linear conversion given by the following equation in each piece is performed:

if
Dᵢ₋₁≦D<Dᵢ
then,
D′=(D₁′−Dᵢ₋₁′)/(Dᵢ−Dᵢ₋₁)×(D−Dᵢ₋₁)+Dᵢ₋₁′
where i=1, 2, . . . , and N

The above conversion can be applied only to the monochrome image. In order to apply the conversion to the color signals such as RGB, the input image data is temporarily converted into YCbCr and the like, and the conversion is performed to a brightness component.

(Image Forming Process Accompanied by Electronic Sort and Image Adjustment by One-Time Scan)

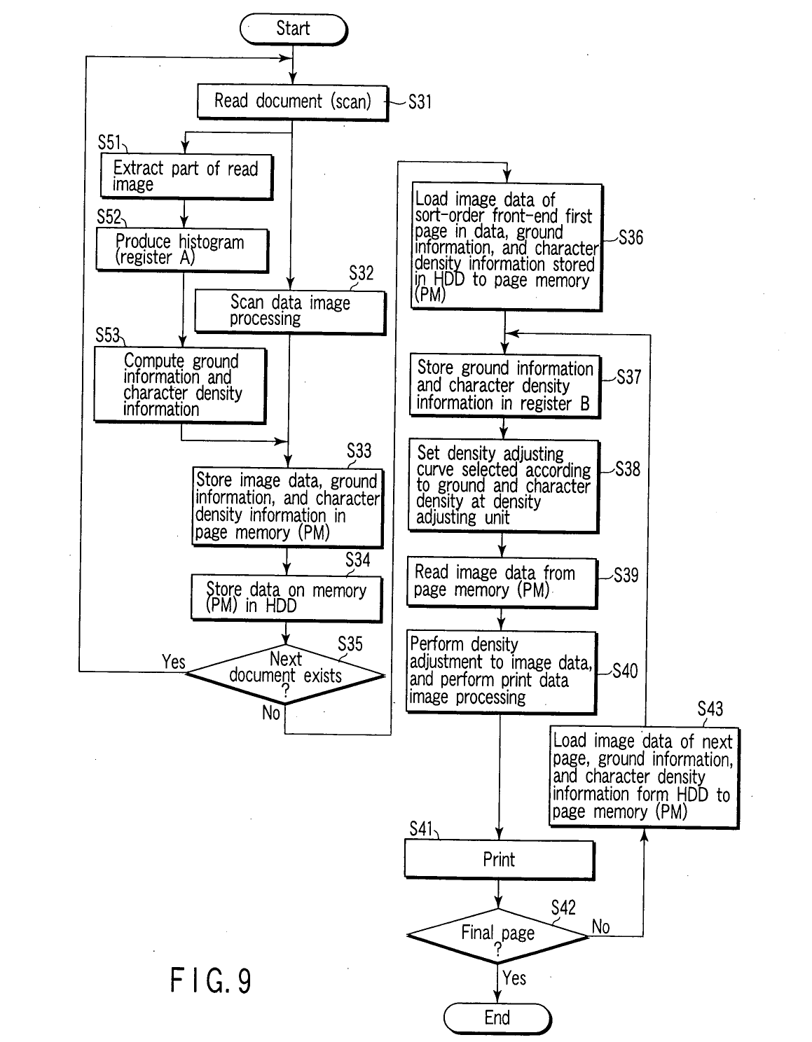

Then, referring to the flowchart shown in FIG. 9, the image forming process accompanied by the automatic density adjustment using an electronic sort function will be described in detail. FIG. 9 shows the image forming process performed by using the electronic sort function in the image forming apparatus 1. The document is conveyed to the document glass with the ADF 10, and the image in the document is read by the scanner unit 11 (S11). The image data (eight bits in each color of RGB) of the document read by the scanner unit 11 is supplied to the scan data image processing unit 12 under the control of the CPU 13 or the like, and desired image processing such as the image conversion process is performed in the scan data image processing unit 12 (S12).

In order to produce the histogram shown in FIGS. 4A and 4B, in parallel with the image processing and the storage process, the histogram computing unit 14 extracts the image information which is of the object of the histogram (S51). In the histogram, the horizontal axis indicates the density and the vertical axis indicates the frequency. As shown in FIG. 4C, values of a three-bit pixel-skipping setting register MB are specified as follows:

MB=0 Absence of pixel skipping,

MB=1 One-pixel (one-line) skipping,

MB=2 Three-pixel (three-line) skipping,

MB=3 Seven-pixel (seven-line) skipping,

MB=4 15-pixel (15-line) skipping,

MB=5 31-pixel (31-line) skipping,

MB=6 63-pixel (63-line) skipping, and

MB=7 127-pixel (127-line) skipping.

In the histogram computing unit 14, only the pixels which are of the object of the histogram are extracted in order to perform the pixel skipping shown by the value of the setting register MB.

As with the absence of the electronic sort, it is possible to specify a count reference area for the image information read by the scanner unit 11. For example, an area smaller than the document can be used for the histogram computation by specifying the start coordinate (xs, ys) and the end coordinate (xe, ye) of the reference area with respect to the upper left of the document. Therefore, because the time for generating the density histogram is also shortened, the time for generating the density histogram can easily be synchronized with the process of storing the image information in the PM 13.

Then, the histogram computing unit 14 generates the density histogram for the image information in which the pixel skipping process has been appropriately performed (S52). As shown in FIG. 4A, for unit of one level, it is necessary that the frequency is recorded for 256 registers A (histogram computing unit). However, as shown in FIG. 4B, it is also possible that the frequency is counted in unit of several levels. In FIG. 4A, WP designates ground peak density, WTH designates ground valley upper limit density, WTL designates ground valley lower limit density, and BP designates character peak density.

The histogram computing unit 14 or the CPU 15 computes the ground information such as WP, WTL, WTH, and BP and the character density information from the computed histogram data (S53). The image information, the ground density information, and the character density information are stored in the PM 13 (S13). Further, the image information and the like on the PM 13 are stored in the HDD 18 (S34).

When the next document exists (S35), the same processes are repeated from Step S31 to Step S34. When all the documents are read (S35), the flow goes to the image forming process, and the image information of a sort-order front-end first page in the documents, the ground information, and the character density information stored in the HDD 18 are loaded onto the PM 13 (S36). Then, the ground information and the character density information are stored in the register MB 32 of FIG. 3 (S37). As shown in FIG. 2, the CPU 15 selects one of the density adjusting curves supplied from the memory unit 14 according to the ground information and the character density information, and sets the selected density adjusting curve in the density adjusting unit 21 (S38). The image information is read from the PM 13 (S39). Then, the density adjustment is performed in each page while the image information is performed by the print data image processing unit 16, the gamma correction and the gradation process are performed to the image information, and the image information is supplied to the print unit 17 (S40). The print unit 17 forms the image on the recording medium according to the image information to which the density adjustment has been performed (S41).

When the document is the final page, the process is ended. When the document is not the final page, the image information, the ground information, and the character density information with respect to the next page of the document are loaded from the HDD 18 to the PM 13 (S43), and the same processes from Step S37 are repeated.

Thus, the image forming process accompanied by the electronic sort and the image adjustment is performed by one-time scan. When compared with the conventional image forming process including the pre-scan and the real scan, the processing speed can be remarkably improved in the image forming process according to the embodiment of the invention.

N in 1

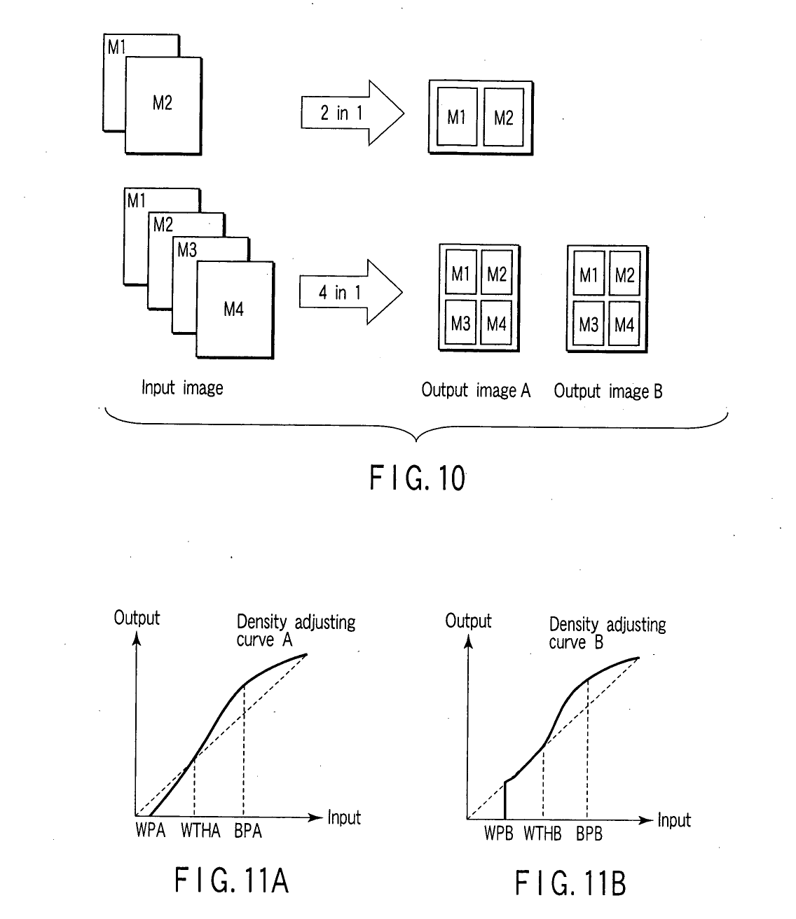

The case in which an N-in-1 process is performed by the electronic sort will be described below. FIG. 10 shows a conceptual view of 2 in 1 and 4 in 1 as examples of the N in 1. Referring to the flowchart of FIG. 9, the N in 1 will be described by citing the 4 in 1 in which the arrangement of the pieces of image information can freely be changed within the page by the electronic sort function.

In the N in 1 mode in which the images of the plural documents are formed in one recording medium, the print data image processing unit 16 prepares the pieces of density adjustment information for the plural density adjustments; generates inner-page arrangement information indicating where the image information is arranged at a position in the recording medium; selects one piece of density adjustment information form the plurality pieces of density adjustment information in response to a switching signal according to the inner-page arrangement information; and performs the density adjustment of the image information based on the selected density adjustment information.

Image information M1 (see FIG. 10) on a first document which is conveyed by the ADF 10 and read by the scanner unit 11 (S31) is processed by the scan data image processing unit 12 (S32). The mage information M1 is temporarily stored in the HDD 18 through the PM 13 (S33 and S34). At this point, in parallel with the process of the scan data image processing unit 12, the histogram computing unit 14 computes WP1, WTL1, WTH1, and BP1 which are of the data for the density adjustment, and WP1, WTL1, WTH1, and BP1 are stored in the HDD 18 together with the image data (S51 to S53, S33, and S34).

Similarly, image information M2 of a second document is read, and the density adjustment computing data such as WP2, WTL2, WTH2, and BP2 and the image data are stored in the HDD 18. Image information M3 of a third document and image information M4 of a fourth document are also sequentially stored in the HDD 18 (S33 and S34).

All the pieces of image information M1 to M4 constitute the first page of the output. When the reading process and the storing process are completed for all the pieces of image information M1 to M4 (S31 to S35, and S51 to S53), the CPU 15 arranges the pieces of image information constituting the first page on the PM 13, and reads the density adjustment computing data for each image data to write the density adjustment computing data in the register MB 32 (S37). When the density adjusting curve shown in FIG. 5B is prepared in the ROM 31, the density adjusting curves (A) to (D) are set in the density adjusting blocks A 34 to D 37 shown in FIG. 3, respectively (S38). Then, the image information is read from the PM 13 (S39). With respect to the image data to which the density adjustment has been performed in each of the density adjusting blocks A 34 to D 37, the switching signal generating unit 33 selection-outputs the image data in response to the switching signal. The switching signal is generated according to an image arrangement (pixel corresponding to image information) and the following criteria. The selection-output process is given by the following expressions:

if (WTHn−WTLn≦THWW and WPn≦THWP)

if (BPn>THBP) then, select result (B)

else select result (D)

else if (BPn≦THBP) then, select result (C)

else select result (A)

where n is a number from 1 to 4 corresponding to the pieces of image information M1 to M4, and THWW, THWP, and THBP are previously prepared threshold values.

In the image data processed in each block, the image data selecting unit 38 performs the appropriate density adjustment to the images arranged in the page, the gamma correction and the gradation process are performed to the image information, and the image information is supplied to the print unit 17 (S40). The print unit 17 forms the image on the recording medium according to the image information to which the density adjustment has been performed (S41). Thus, even in the 4-in-1 process by the electronic sort, the image forming process accompanied by the image adjustment can be performed by one-time scan at high speed.

Downsizing of Density Adjusting Block (1)

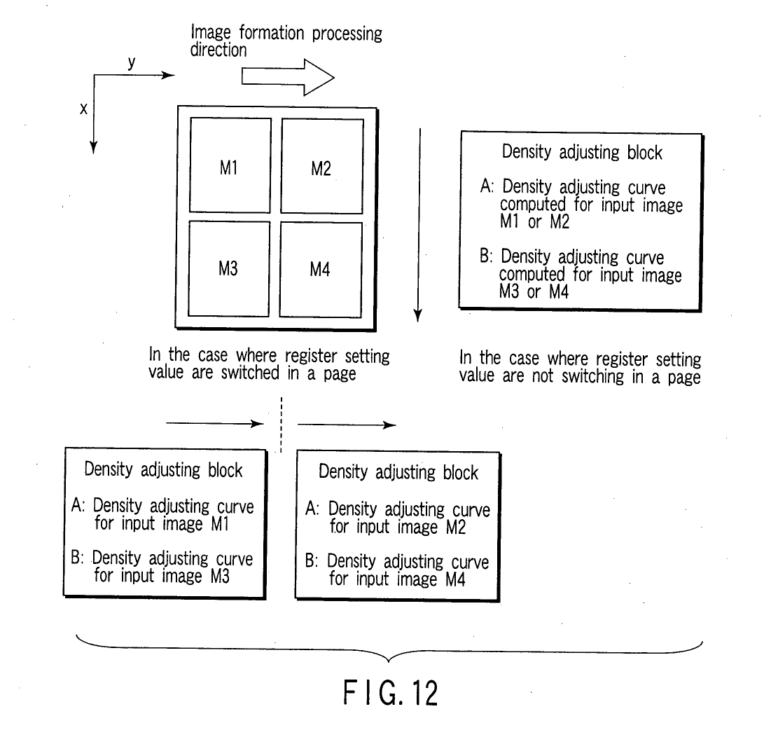

The case in which the density adjusting unit 21 includes the density adjusting block A 34 and the density adjusting block B 35 will be described below. Namely, the density adjusting block C 36 and the density adjusting block D 37 are deleted from the density adjusting unit 21 by using the density adjusting curves shown in FIGS. 11A and 11B, and the density adjusting unit 21 includes only the density adjusting block A 34 and the density adjusting block B 35. As shown in FIG. 12, when the image data in the vertical direction (y-direction in FIG. 12) with respect to the proceeding direction of the outputted sheet is being transferred in unit of line, the front-end two pieces density adjustment computing data for two pieces of image information (image information M1 and image information M3) are written in the resisters of the density adjusting blocks A and B. Then, the registers of the density adjusting blocks A and B are updated by the two pieces of density adjustment computing data for the remaining two pieces of image information (image information M2 and image information M4) at timing (broken line in FIG. 12) in which the final lines of the front-end two pieces of image information are processed. Therefore, a circuit size of the density adjusting block can be decreased.

Downsizing of Density Adjusting Block (2)

Unlike the above case, when the register is difficult to change within the page from viewpoints of image transfer speed and register access speed, the setting values are not changed, but the density adjusting block A is used for the pieces of image information M1 and M2 and the density adjusting block B is used for the pieces of image information M3 and M4. The curve computed (selected) from the pieces of image information M1 and M2 is set as the density adjusting curve set in the density adjusting block A. When the same results are not obtained between the curves computed from the pieces of image information M1 and M2, assuming that priority is (A)>(B)>(C)>(D), the curve having the highest priority result is set in the density adjusting block A. Similarly, the curve having the highest priority result is also set in the density adjusting block B.

Accordingly, the switching signal generating unit 33 generates the switching signal while the switching position is set at a boundary coordinate between the image information M1 (and M2) and the image information M3 (and M4) in the x-direction of FIG. 12, and the pieces of image data are outputted while the image data selecting unit 38 switches the pieces of image data. Therefore, the results in which the density adjusting block A affects the pieces of image information M1 and M2 and the density adjusting block B affects the pieces of image information M3 and M4 are obtained. This method also enables the image adjustment for the image formation of the N in 1 by the relatively small density adjusting block circuit.

Embedding and Compressing Process of Density Adjustment Computing Data When a marker capable of defining a user or an application can be inserted into the image information, the PM 13 or the HDD 18 stores the density information supplied from histogram computing unit 14 in the marker in compressing and storing the image information. The PM 13 or the HDD 18 reads the density information from the marker to expand the density information, and the density adjustment of the image information can be performed based on the expanded density information.

Namely, as described above, the density adjustment can be realized by the method in which both the density adjustment computing data (density histogram and the like) and the image information are stored in the storage means. In addition, depending on the image compression method (format), it is possible that the density adjustment computing data is embedded and compressed in the image information and the density adjustment computing data extracted in the expansion is set in the register MB 32.

For example, when the data compression pursuant to JPEG format (JFIF format) is adopted as the image data format, the area of application marker segment APPn which is provided for the use of applications can be utilized. Because contents defined as the JFIF file are described in APP0 (marker: FFE0), the markers (FFE1 to FFED) except for APP0 (FFE1 to FFED) are utilized. The contents defined in the forms of field length information of two bytes and the pieces of density adjustment computing data WP, WTL, WTH, and BP of each one byte can be described in the markers (FFE1 to FFED). Accordingly, in the expansion, the pieces of density adjustment computing data WP, WTL, WTH, and BP can be recognized by reading the markers (FFE1 to FFED). Since the pieces of density adjustment computing data WP, WTL, WTH, and BP can be dealt with as a part of the image data format, the storage area can be saved, and the configuration can also be simplified in the information management.

As described above, those skilled in the art can realize the invention by the various embodiments. However, it is further understood by those skilled in the art that various changes and modifications may be easily made in the invention without departing from the spirit and scope thereof and that the invention may be applied to various changes and modifications without any inventive ability. Accordingly, the invention covers the broad scope consistent with the disclosed principle and novel features, and the invention is not limited to the above-described embodiments.

What is claimed is:

1. An image forming apparatus comprising:
a reading unit which reads a document image to output image information;
a memory unit which stores the image information read by the reading unit in a storage area;
a computing unit which computes a density histogram of the image information from the reading unit;
an image processing unit which performs density adjustment to the image information read from the memory unit according to the density histogram computed by the computing unit, and outputs the image information;
an image forming unit which forms an image based on the image information to which the image processing unit has performed the density adjustment; and
a control unit which controls the reading unit, the memory unit, the computing unit, the image processing unit, and the image forming unit such that the reading unit reads the image information of the document only once, the computing unit receives the image information to compute the density histogram during an interval in which the image information is stored in the memory unit, the memory unit reads the image information to supply the image information to the image processing unit, the image processing unit performs the density adjustment to the read image information according to the density histogram and outputs the image information, and the image forming unit forms the image to which the density adjustment has been performed according to the density histogram of the document image by one-time image reading of the reading unit.

2. An image forming apparatus according to claim 1, further comprising an auto document feeder (ADF) unit which continuously supplies a plurality of documents to the reading unit,
wherein the control unit continuously supplies said plurality of documents to the reading unit by using the ADF feeder unit; causes the reading unit to perform only one-time reading action per one sheet of document; causes the memory unit to perform a storing process to the read image information and causes the memory unit to perform a computing process to the read image information simultaneously; reads the image information from the memory unit to supply the image information to the image processing unit; causes the image processing unit to perform the density adjustment to the read image information according to the density histogram to output the image information; and controls each unit in order to cause the image forming unit to form the image in which the density adjustment has been performed, thereby the continuous image formation accompanied by the density adjustment according to image densities for said plurality of documents is performed by continuously performing the one-time reading action per one sheet of document.

3. An image forming apparatus according to claim 1, wherein the computing unit computes the density histogram based on the remaining pieces of image information in which pixel skipping has been performed to the image information from the reading unit in each line.

4. An image forming apparatus according to claim 1, wherein the computing unit specifies a start coordinate and an end coordinate in a reference area in a whole area of the document with respect to the image information from the reading unit, and computes the density histogram for the image information within the reference area.

5. An image forming apparatus according to claim 1, wherein the memory unit stores the read image information of at least one page of the document.

6. An image forming apparatus according to claim 1, wherein the control unit or the image processing unit detects ground information and character density information from the density histogram.

7. An image forming apparatus according to claim 6, wherein the memory unit stores the ground information and character density information detected from the density histogram.

8. An image forming apparatus according to claim 6, wherein the memory unit has a dedicated register to store the ground information and character density information detected from the density histogram.

9. An image forming apparatus according to claim 6, wherein the image processing unit selects one density adjusting curve from a plurality of previously prepared density adjusting curves according to the ground information and the character density information, and performs the density adjustment of the image information according to the selected density adjusting curve.

10. An image forming apparatus according to claim 6, wherein the image processing unit selects one density adjusting curve in which the ground is cut from a plurality of previously prepared density adjusting curves by using the ground information, and performs the density adjustment of the image information according to the selected density adjusting curve.

11. An image forming apparatus according to claim 1, wherein the computing unit computes the density histogram after performing predetermined image processing to the image information from the reading unit.

12. An image forming apparatus according to claim 1, wherein an image data format is standardized between the image information of the computing unit and the image information of the image processing unit.

13. An image forming apparatus according to claim 1, wherein the computing unit computes the density histogram while one pixel of the image information outputted from the reading unit is not set at one frequency but a plurality of pixels are set at one frequency.

14. An image forming apparatus according to claim 1, wherein the image processing unit performs gradation conversion of the image information by a function in which a dynamic range of the image information is determined by a maximum value and a minimum value of the read image information.

15. An image forming apparatus according to claim 1, wherein the image processing unit performs the gradation conversion of the image information by a function in which a dynamic range of the image information is determined by a maximum value and a minimum value of the read image information, and further performs the density adjustment according to the density histogram computed by the computing unit.

16. An image forming apparatus according to claim 1, wherein the memory unit stores density adjustment information for the density adjustment of the image processing unit together with the image information in unit of document reading, and the image processing unit performs the density adjustment of the image information according to the density adjustment information, in an N in 1 mode in which the images of said plurality of documents are formed in one recording medium.

17. An image forming apparatus according to claim 1, wherein the image processing unit prepares the density adjustment information for said plurality of density adjustments, generates inner-page arrangement information indicating where the image information is arranged at a position in a recording medium, selects one piece of density adjustment information form said plurality pieces of density adjustment information in response to a switching signal according to the inner-page arrangement information, and performs the density adjustment of the image information based on the selected density adjustment information, in an N in 1 mode in which images of said plurality of documents are formed in one recording medium.

18. An image forming apparatus according to claim 1, wherein, in the case where a marker capable of defining a user or an application can be inserted into the image information, the memory unit stores the density information supplied from the computing unit in the marker when the image information is compressed and stored; reads the density information from the marker to expand the density information; and performs the density adjustment of the image information based on the expanded density information.

19. An image forming method comprising:
reading image information of a document only once;
computing a density histogram based on the image information during an interval in which the image information is stored in a storage area;
reading the image information from the storage area, and performing density adjustment to the read image information according to the density histogram to output the image information; and
forming an image according to the outputted image information.

20. An image forming method according to claim 19, wherein an auto document feeder (ADF) which continuously supplies a plurality of documents is used to continuously supply said plurality of documents, only one-time reading action is performed per one sheet of document, a process of storing the read image information in the storage area and a process of computing the density histogram of the read image information are performed at the same time, the image information is read from the storage area to perform the density adjustment to the image information according to the density histogram, and an image is formed on a recording medium according to the image information to which the density adjustment has been performed.
